(19) United States
(12) Patent Application Publication
(10) Pub. No.: US 2012/0098150 A1
(43) Pub. Date: Apr. 26, 2012

(54) NANOFIBER MANUFACTURING APPARATUS AND NANOFIBER MANUFACTURING METHOD

(76) Inventors: Takahiro Kurokawa, Osaka (JP); Hiroto Sumida, Nara (JP); Masahide Yokoyama, Osaka (JP); Kazunori Ishikawa, Osaka (JP)

(21) Appl. No.: 13/379,428

(22) PCT Filed: Jun. 21, 2010
(86) PCT No.: PCT/JP2010/004116

§ 371 Date: Dec. 20, 2011

(30) Foreign Application Priority Data
Jun. 25, 2009 (JP) 2009-150618

(51) Int. Cl. B29B 9/06; B82Y 40/00

(52) U.S. Cl. 264/10; 425/6; 977/840

(57) ABSTRACT

In a nanofiber manufacturing apparatus (1) which produces nanofibers by electrically stretching a solution in space, a hollow supporting unit (32) which is rotated around an axial line AL by a motor (41) supports a cartridge (33) which supplies a solution (20) stored therein, a pressurizing member (38) is pressurized by air introduced through a rotary joint (43) so that the solution (20) flows into an interior space (34a) of an effusing body (34) which is rotated together with the supporting body (32), and the solution (20) is radially effused from effusing holes (34c) by the pressure of the air and centrifugal force due to the rotation of the effusing body (34).

### TECHNICAL FIELD

The present invention relates to a nanofiber manufacturing device and a nanofiber manufacturing method for manufacturing fibrous substances (nanofibers) having a submicron- or a nanometer-scale diameter.

### BACKGROUND ART

Electrospinning (charge induction spinning) has been known as a method of manufacturing nanofibers. In the electrospinning, a solution prepared by dispersing or dissolving a solute such as a resin in a solvent is effused (ejected) into space through a nozzle or the like while being charged, and then electrically stretched in flight such that nanofibers are produced. Specifically, the solvent gradually vaporizes from the charged solution while the solution effused into space is in flight, so that the solution in flight gradually decreases in volume, but charges to the solution accumulate in the solution.

As a result, the charge density of the solution gradually increases in flight. The solvent continues to vaporize, and the charge density of the solution further increases. Eventually, the solution is explosively stretched into a line when the Coulomb force generated in the solution and repulsive to the surface tension of the solution surpasses the surface tension (hereinafter the stretching is referred to as electrostatic stretching). The electrostatic stretching exponentially occurs in space one after another, and nanofibers having diameters of sub-micron orders are thereby produced.

There are known nanofiber manufacturing apparatuses to which such a technique of electrostatic stretching is applied and which radially effuse solutions from their effusing holes using centrifugal force (for example, see PTL 1 and PTL 2). In such prior art, a solution is supplied into a cylindrical container having small-diameter effusing holes in its circumference surface for effusion of the solution, and the solution is effused from the effusing holes by centrifugal force generated by rotating the cylindrical container. In the prior art disclosed in PTL 2, a cylindrical container has a structure such that a weir provided inside the cylindrical container stabilizes the amount of a solution therein.

### CITATION LIST

### Patent Literature

[PTL 1]
Japanese Unexamined Patent Application Publication Number 2008-150769
[PTL 2]
Japanese Unexamined Patent Application Publication Number 2008-285792

### SUMMARY OF INVENTION

### Technical Problem

In order to produce quality nanofibers having a uniform fiber diameter, it is necessary to effuse a solution into space in the form of a thread having a uniform diameter. However, in the prior art disclosed in PTL 1 and PTL 2, the amount or condition of the solution effused from effusing holes unavoidably fluctuates when there is a change in the amount of the solution in the cylindrical container, because the mechanism for effusion of the solution depends only on centrifugal force. Accordingly, there have been a problem that the effused solution fails to form a thread but forms droplets to scatter without electrostatic stretching, and a problem that, even when electrostatic stretching occurs, generated nanofibers are poor in quality with uneven fiber diameters, which prevents increase in productivity.

The present invention has an object of providing a nanofiber manufacturing apparatus and a nanofiber manufacturing method for stable and efficient production of nanofibers having a uniform fiber diameter.

### Solution to Problem

In order to achieve the object, a nanofiber manufacturing apparatus according to the present invention produces nanofibers by electrically stretching a solution in space, and includes: an effusing body having an interior space into which the solution is supplied and a plurality of effusing holes through which the solution is radially effused from the interior space; a solution supply container having a connection to the effusing body in a detachable manner and configured to supply the effusing body with the solution stored in the solution supply container; a supporting body which supports the solution supply container and the effusing body while maintaining the connection between the solution supply container and the effusing body; a pressurizing unit configured to pressurize an inside of the solution supply container so that the solution is supplied from the solution supply container to the interior space of the effusing body, when the connection between the solution supply container and the effusing body is maintained; and a charging unit configured to charge the solution by applying an electric charge to the solution via the effusing body.

With this, it is possible to make the solution effused from the effusing holes in a uniform condition between the effusing holes, and the condition can be stabilized. As a result, the produced nanofibers have a consistent quality.

Furthermore, the supporting body may maintain the connection between the solution supply container and the effusing body, and rotatably supports the solution supply container and the effusing body, and the nanofiber manufacturing apparatus may further include a rotating unit configured to rotate the effusing body and the solution supply container integrally.

With this, not only can the effused solution be in a uniform condition between the effusing holes but also can the deposited nanofibers be in a uniform condition. It is therefore possible to produce uniform unwoven cloth by depositing nanofibers.

Furthermore, the pressurizing unit may be configured to apply the pressure to the inside of the solution supply container by introducing a fluid into the inside of the solution supply container.

With this, pressure is applied to the solution, which is a fluid, by a fluid so that the solution can be pressurized more evenly than by mechanically pressurized using a mechanical structure. In particular, pressurization and rotation can be easily performed at the same time when the solution supply container rotates.

Furthermore, the fluid may be a gas, and the solution supply container may include a partition which isolates the solution from the introduced gas.

Such a simple structure allows effusion of the solution, and a simple general structure can be used even when the solution supply container and the effusing body rotates integrally.

Furthermore, the fluid may be the solution.

That is, the solution is pushed into the inside of the solution supply container using an external pump, for example. With this, the solution can be continuously supplied to the effusing body.

Furthermore, in order to achieve the object, a nanofiber manufacturing method according to the present invention is to be used by a nanofiber manufacturing apparatus which produces nanofibers by electrically stretching a solution in space and includes: an effusing body having an interior space into which the solution is supplied and a plurality of effusing holes through which the solution is radially effused from the interior space; a solution supply container having a connection to the effusing body in a detachable manner and configured to supply the effusing body with the solution stored in the solution supply container; a supporting body which supports the solution supply container and the effusing body while maintaining the connection between the solution supply container and the effusing body; a pressurizing unit configured to pressurize an inside of the solution supply container so that the solution is supplied from the solution supply container to the interior space of the effusing body, when the connection between the solution supply container and the effusing body is maintained; and a charging unit configured to charge the solution by applying an electric charge to the solution via the effusing body, and the nanofiber manufacturing method includes: coupling the solution supply container and the effusing body; supporting the joined solution supply container and the effusing body in a detachable manner; pressurizing an inside of the solution supply container so that the solution is supplied from the solution supply container to the interior space of the effusing body; and effusing the solution supplied from the solution supply container through the effusing holes while charging the solution using the charging unit.

With this, it is possible to make the solution effused from the effusing holes in a uniform condition between the effusing holes, and the condition can be stabilized. As a result, the produced nanofibers have a consistent quality.

Furthermore, a nanofiber manufacturing apparatus which produces nanofibers by electrically stretching a solution in space may include: a solution supply container which includes a cylindrical container storing the solution and supplies the solution; an effusing body which has an interior space communicating with the cylindrical container and effusing holes through which the solution is radially effused from the interior space; a supporting body holding a first joined body formed of the solution supply container and the effusing body, detachably in an direction along the axial line of the cylindrical container, the supporting body being rotatable around the axial line; a pressurizing unit which pushes the solution from the solution supply container into the interior space by pressurizing the inside of the cylindrical container to cause the solution to be effused through the effusing holes when the first joined body is supported by the supporting body so that the solution supply container communicates with the effusing body; a rotating unit configured to rotate the effusing body and the cylindrical container together around and axial line via the supporting body; and a charging unit configured to charge the solution by applying an electric charge to the solution via the effusing body.

Furthermore, a nanofiber manufacturing apparatus which produces nanofibers by electrically stretching a solution in space may include: a solution supply container which includes a cylindrical container storing the solution and supplies the solution; a holding body which is configured to detachably hold the solution supply container and to which a pressurizing unit configured to pressurize an inside of the cylindrical container is connected; an effusing body which has an interior space communicating with the cylindrical container and effusing holes through which the solution is radially effused from the interior space; a supporting body which holds a second joined body having the effusing body at one end and the solution supply container and the holding body on the other end, detachably in an direction along the axial line of the cylindrical container so as to provide communication between the solution supply container and the effusing body; a rotating unit configured to rotate the effusing body and the cylindrical container together around and axial line via the supporting body; and a charging unit configured to charge the solution by applying an electric charge to the solution via the effusing body; wherein the solution is pushed into the interior space and effused through the effusing holes by actuating the pressurizing unit when the solution supply container and the effusing body communicate with each other.

Furthermore, a nanofiber manufacturing method for producing nanofibers by electrically stretching a solution in space may include: coupling a solution supply container which includes a cylindrical container storing the solution and supplies the solution and an effusing body having an interior space communicating with the cylindrical container and a plurality of effusing holes through which the solution is radially effused from the interior space, to form a first joined body; having the first joined body held on a supporting body in a manner such that the first joined body is detachable in a direction along an axial line of the cylindrical container, the supporting body being rotatable around the axial line of the cylindrical container; pushing the solution from the solution supply container into the interior space by pressurizing the inside of the cylindrical container; and effusing the solution through the effusing holes while charging the solution using a charging unit, the effusion of the solution being promoted by centrifugal force generated by rotating the effusing body and the cylindrical container together around an axial line via the supporting body using a rotating unit.

Furthermore, a nanofiber manufacturing method for producing nanofibers by electrically stretching a solution in space may include: coupling a solution supply container which includes a cylindrical container staring the solution and supplies the solution and a holding body detachably holds the solution supply container and to which a pressurizing unit for pressurizing the inside of the cylindrical container, to form a second joined body; having the second joined body held on one end of a supporting body which has an effusing body installed on the other end of the supporting body and having an interior space communicating with the cylindrical container and a plurality of effusing holes through which the solution is radially effused from the interior space; pushing the solution from the solution supply container into the interior space by pressurizing the inside of the cylindrical container; and effusing the solution through the effusing holes while charging the solution using a charging unit, the effusion of the solution being promoted by centrifugal force generated by rotating the effusing body and the cylindrical container together around an axial line via the supporting body using a rotating unit.

### Advantageous Effects of Invention

In a configuration according to the present invention, a solution supply container which stores a solution in a cylindrical container and supplies the solution and an effusing body having effusing holes through which the solution is radially effused from an interior space are joined, and the inside of the cylindrical container is pressurized so that the solution is pushed from the solution supply container and effused through the effusing holes. With this, the amount of the solution effused through the effusing holes can be stabilized and nanofibers having a uniform fiber diameter can be stably and efficiently produced.

### BRIEF DESCRIPTION OF DRAWINGS

FIG. 1 illustrates a perspective view of a nanofiber manufacturing apparatus according to an embodiment of the present invention.

FIG. 2 illustrates a sectional view of the nanofiber manufacturing apparatus according to the embodiment of the present invention.

FIG. 3 illustrates a sectional view of a solution effusing unit installed to the nanofiber manufacturing apparatus according to the embodiment of the present invention.

FIG. 4 shows a method of installing the solution supply container to the nanofiber manufacturing apparatus according to the embodiment of the present invention.

FIG. 5 describes functions of a solution effusing unit in the nanofiber manufacturing apparatus according to the embodiment of the present invention.

FIG. 6 shows a method of installing the solution supply container to the nanofiber manufacturing apparatus according to the embodiment of the present invention.

FIG. 7 shows a method of installing the solution supply container to the nanofiber manufacturing apparatus according to the embodiment of the present invention.

FIG. 8 illustrates a sectional view of a solution effusing unit installed to the nanofiber manufacturing apparatus according to the embodiment of the present invention.

FIG. 9 shows a method of installing the solution supply container to the nanofiber manufacturing apparatus according to the embodiment of the present invention.

FIG. 10 shows a method of installing the solution supply container to the nanofiber manufacturing apparatus according to the embodiment of the present invention.

FIG. 11 shows a method of replacing solution effusing units in the nanofiber manufacturing apparatus according to the embodiment of the present invention.

FIG. 12 shows a method of replacing solution effusing units in the nanofiber manufacturing apparatus according to the embodiment of the present invention.

### DESCRIPTION OF EMBODIMENTS

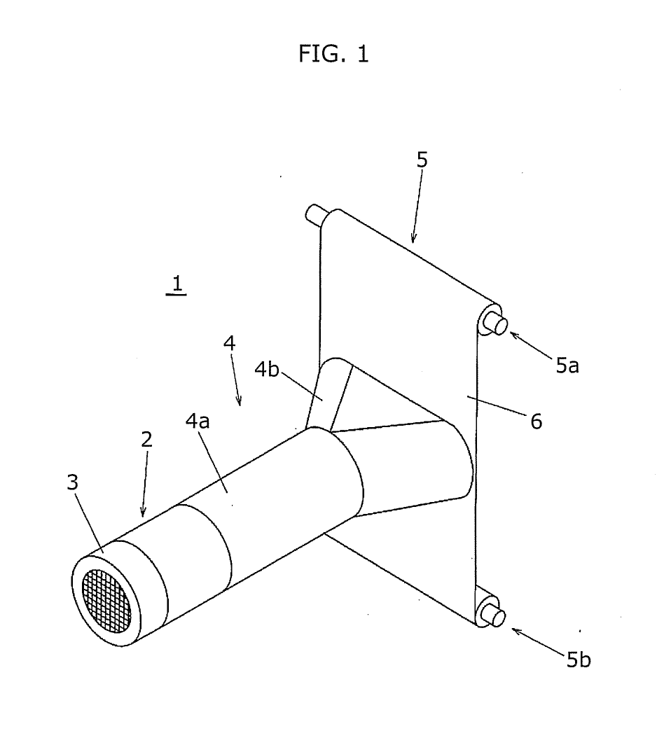

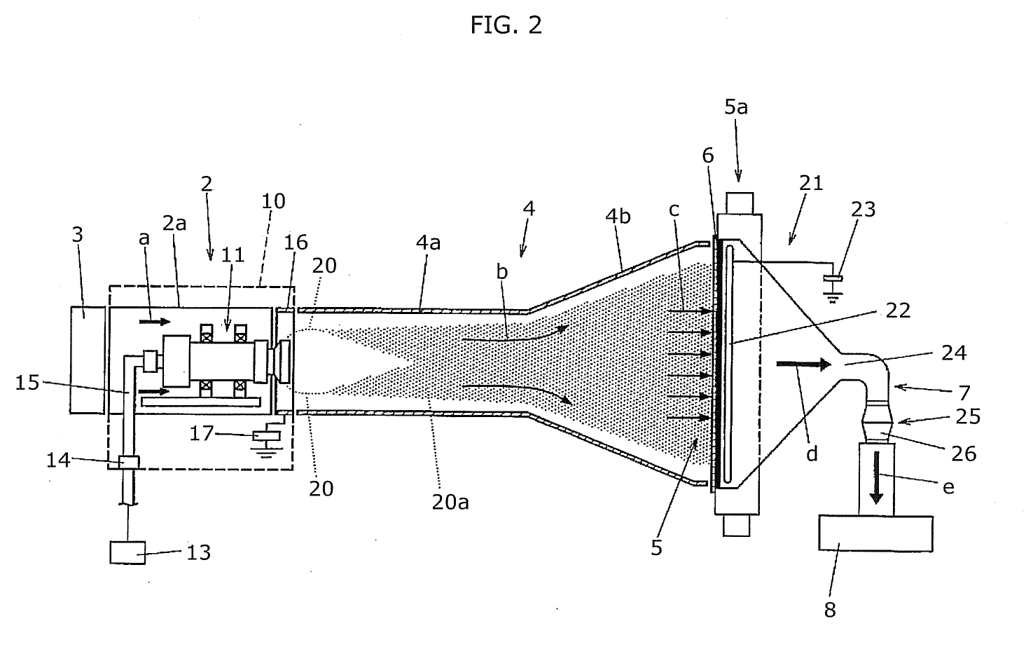

The following describes an embodiment of the present invention with reference to the drawings. FIG. 1 and FIG. 2 shows a nanofiber manufacturing apparatus 1 which has a function of producing nanofibers by electrically stretching a solution in space. The nanofiber manufacturing apparatus 1 includes an effusing device 2 which effuses the solution, an air blower device 3 provided on one side of the effusing device 2, and a guide body 4 and a collection device 5 arranged in series on the other side of the effusing device 2.

The air blower device 3 and the guide body 4 function as flow deflection units. In the present embodiment, the effusing device 2 centrifugally effuses the solution into space without contacting a supplied solution with air before effusion, and charges the solution by applying an electric charge to the solution.

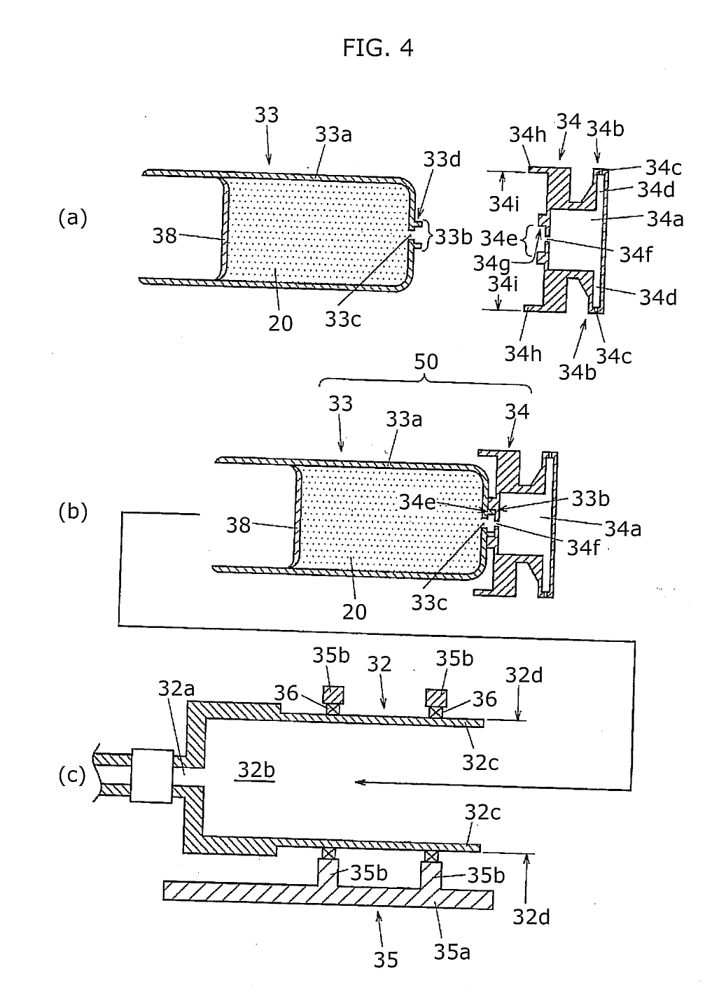

As shown in the cross-sectional view in FIG. 2, the effusing device 2 includes a solution effusion mechanism 11 disposed in an air channel body 2a having a cylindrical shape. The solution effusion mechanism 11 radially effuses a solution. The solution effusion mechanism 11 incorporates a cartridge (see a cartridge 33 shown in FIG. 4) which is a cylindrical solution supply container containing a solution, and radially effuses a solution 20 by an effusing force generated by pressure of air supplied from an air supply source 13 provided externally to the solution effusion mechanism 11 and centrifugal force generated by rotation.

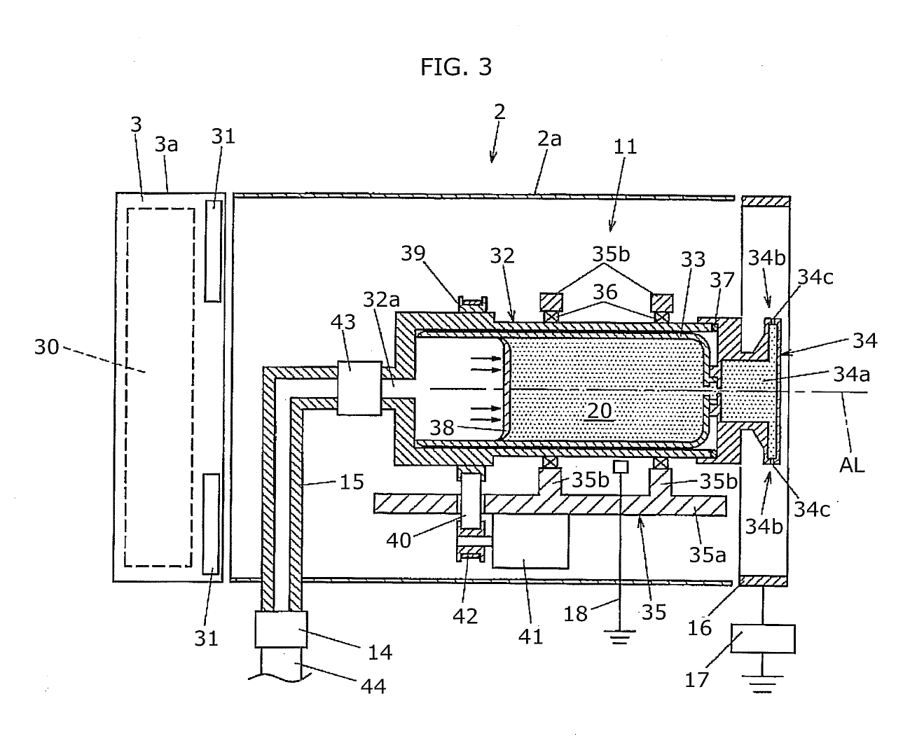

In the solution effusion mechanism 11, an annular electrode 16 having an annular shape is disposed around the circumference of an effusing body (see an effusing body 34 shown in FIG. 3) from which the solution 20 is effused. A charging power supply 17 applies a voltage to the annular electrode 16 so that the annular electrode 16 charges the effused solution 20. At this time, the air blower device 3 is actuated to push air in the air channel body 2 in a downstream direction (arrows a) so that the solution 20 effused from the solution effusion mechanism 11 flows from the effusing device 2 into the guide body 4.

In the present embodiment, the solution effusion mechanism 11 in the air channel body 2a, the annular electrode 16, and the charging power supply 17, an air supply joint 14, and an air tube 15 for air supply from the air supply source 13, are collectively referred to as a single unit, that is, a solution effusing unit 10. More than one solution effusing unit 10 in such a configuration are prepared in order to achieve continuous production of nanofibers by replacing one solution effusing unit 10 with another when the solution in the cartridge incorporated in the solution effusion mechanism 11 is consumed.

Note that the solution effusing unit 10 needs to include only the solution effusion mechanism 11. The charging power supply 17 or the air supply source 13 may be shared by more than one of the solution effusing units 10.

The solution 20 effused from the solution effusion mechanism 11 is gradually turned into nanofibers 20a by electrostatic stretching in the process of flowing in a straight section 4a of the guide body 4 in a downstream direction (arrows b). The flow of the nanofibers 20a continuously diffuse in a flare part 4b due to a hood shape of the flare part 4b, slowing gradually. The nanofibers 20a transferred in a high density thereby diffuse evenly and widely to be in a low density. The diffused nanofibers 20a reach the collection device 5 (arrows c), and are trapped by a surface of a deposition member 6. Note that the solution 20 and the nanofibers 20a are not distinguishable from each other and that there is not a definite boundary therebetween, because the solution 20 turns into nanofibers 20a while being electrically stretched in the process of production of the nanofibers 20a.

Here, examples of resins to be a material for the nanofibers 20a include high-molecular substances such as polypropylene, polyethylene, polystyrene, polyethylene oxide, polyethylene terephthalate, polybutylene terephthalate, polyethylene naphthalate, poly-m-phenylene terephthalate, poly-p-phenylene isophthalate, polyvinylidene fluoride, polyvinylidene fluoride-hexafluoropropylene copolymer, polyvinyl chloride, polyvinylidene chloride-acrylate copolymer, polyacrylonitrile, polyacrylonitrile-methacrylate copolymer, polycarbonate, polyarylate, polyester carbonate, polyamide, aramid, polyimide, polycaprolactone, polylactic acid, polyglycolic acid, collagen, polyhydroxybutyric acid, polyvinyl acetate, polypeptide, and a copolymer thereof. The resin may be the one selected from among the above substances or a mixture thereof. These substances are given for illustrative purposes only and the present invention is not limited to the resins.

Examples of the solvent to be used as the solution 20 include volatile organic solvents. Specific examples of the solvent include methanol, ethanol, 1-propanol, 2-propanol, hexafluoroisopropanol, tetraethylene glycol, triethylene glycol, dibenzyl alcohol, 1,3-dioxolane, 1,4-dioxane, methyl ethyl ketone, methyl isobutyl ketone, methyl-n-hexyl ketone, methyl-n-propyl ketone, diisopropyl ketone, diisobutyl ketone, acetone, hexafluoroacetone, phenol, formic acid, methyl formate, ethyl formate, propyl formate, methyl benzoate, ethyl benzoate, propyl benzoate, methyl acetate, ethyl acetate, propyl acetate, dimethyl phthalate, diethyl phthalate, dipropyl phthalate, methyl chloride, ethyl chloride, methylene chloride, chloroform, o-chlorotoluene, p-chlorotoluene, chloroform, carbon tetrachloride, 1,1-dichloroethane, 1,2-dichloroethane, trichloroethane, dichloropropane, dibromoethane, dibromopropane, methyl bromide, ethyl bromide, propyl bromide, acetic acid, benzene, toluene, hexane, cyclohexane, cyclohexanone, cyclopentane, o-xylene, p-xylene, m-xylene, acetonitrile, tetrahydrofuran, N,N-dimethylformamide, N,N-dimethylacetamide, dimethyl sulfoxid, pyridine, and water. The solvent may be the one selected from among the above substances or a mixture thereof. These substances are given for illustrative purposes only and the solution 20 used in the present invention is not limited to the solvents above.

In addition, an additive such as an aggregate or a plasticizer may be added to the solution 20. The additive may be an oxide, a carbide, a nitride, a boride, a silicide, a fluoride, or a sulfide. However, in view of properties such as thermal resistance and processability, an oxide is preferable. Examples of the oxide include Al₂O3, SiO2, TiO2, Li₂O, Na₂O, MgO, CaO, SrO, BaO, B₂O₃, P₂O₅, SNO₂, ZrO₂, K₂O, Cs₂O, ZnO, Sb₂O₂, As₂O₃, CeO₂, V₂O₅, Cr₂O₃, MnO, Fe₂O₃, CoO, NiO, Y₂O₃, Lu₂O₃, Yb₂O₃, HfO₂, and Nb₂O₅. The additive may be the one selected from among the above oxides or a mixture thereof. These substances are given for illustrative purpose only and the additive to be added to the solution 20 in the present invention is not limited to the substances. The mixture ratio between the solvent and the resin in the solution 20 depends on the selected solvent and resin. A desirable amount of solvent accounts for approximately 60 to 98 weight percent.

Since solvent vapor flows without stagnating when the solution 20 and generated nanofibers 20a are transferred by a gas flow and the gas flow is drawn by a suction device 26 as in the present embodiment, the solution 20 containing 50% or more by weight of solvent sufficiently vaporizes, causing electrostatic stretching. It is therefore possible to produce thinner nanofibers 20a which can be produced from a thin solution containing a less solute. Furthermore, since the solution 20 has a wider adjustable range, a wider variety of properties can be expected for the nanofibers 20a to be produced.

The collection device 5 collects the nanofibers 20a released from the effusing device 2. As shown in FIG. 1, the collection device 5 is configured so as to have the nanofibers 20a attached and deposited on the deposition member 6 which is provided as a member feeding unit 5a in the form of a rolled sheet and is moved at a regular speed in relative to the flare part 4b by rolling the deposition member 6 around a member retrieving unit 5b.

The deposition member 6 is a reticular member, such as a long-length cloth of aramid fibers, which easily transmits the gas flow and traps the nanofibers 20a. The nanofibers 20a reach the deposition member 6 and are separated from the gas flow, so that only the nanofibers 20a are deposited on a surface of the deposition member 6 so as to form unwoven cloth thereon. The deposited nanofibers 20a are rolled around the member retrieving unit 5b together with the deposition member 6. It is preferable to coat the surface of the deposition member 6 with Teflon (Teflon is a registered trademark) to make it easier to remove the deposited nanofibers 20a from the deposition member 6.

A drawing unit 7 is provided on a back side of the collection device 5. The drawing unit 7 is not shown in FIG. 1. The drawing unit 7 is a device which draws the nanofibers 20a to the deposition member 6. In the present embodiment, the drawing unit 7 includes an electric-field drawing device 21 and a gas drawing device 25 to allow drawing of the nanofibers 20a using either or both of the different methods at one time. The gas drawing device 25 is installed behind the deposition member 6 and draws the nanofibers 20a to the deposition member 6 by suctioning a gas flow. In the present embodiment, the gas drawing device 25 includes a suction device 26 and a concentration part 24.

The concentration part 24, which is a funnel-shaped member flaring toward a direction opposite to the flare part 4b, receives the gas flow spread in the flare part 4b and concentrates the gas flow before the gas flow reaches the suction device 26. The suction device 26 is an air blower such as a sirrocco fan or an axial-flow fan which accelerates slowing gas flow by compulsorily suctioning the gas flow passing through the deposition member 6. The suction device 26 suctioning the gas flow simultaneously suctions the solvent vaporized during the production of the nanofibers 20a, so that the solvent, which may be flammable, in the effusing device 2 is prevented from reaching an explosible concentration, thus enabling safe use of the nanofiber manufacturing apparatus.

The electric-field drawing device 21, which includes a drawing electrode 22 and a drawing power supply 23, draws the charged nanofibers 20a to the deposition member 6 by an electric field. The drawing electrode 22 is an electrode which generates an electric field to draw the charged nanofibers 20a. In the present embodiment, the drawing electrode 22 is a metal mesh through which gas flows, and is provided over an opening of the flare part 4b. The drawing power supply 23 is a direct-current power supply which is capable of maintaining the drawing electrode 22 at a predetermined voltage and in a predetermined polarity. In the present embodiment, the drawing electrode 22 can be freely set at a voltage within a range of 0 V (ground state) to 200 kV and in either polarity. Examples of the drawing electrode 22 include not only the drawing electrode 22 described in the present embodiment but also a bar-shaped electrode having a length as large as the width of the deposition member 6 and a predetermined width or an array of drawing electrodes 22 having a bar shape.

A collecting device 8 separates, from the gas flow, the solvent vaporized from the solution 20 and collects the separated solvent. A configuration of the collecting device 8 depends on the type of the solvent used in the solution 20. Examples of the collecting device 8 include a device which cools a gas to condense a solvent therein and collect it, a device in which only a solvent is adsorbed by activated carbon or zeolite, a device in which a solvent is dissolved in a liquid, and a combination thereof.

The following describes a structure of the effusing device 2 in detail with reference to FIG. 3 and FIG. 4. In the air channel body 2a, which is a hollow cylindrical member, a mechanical member 35 is supported by a supporting bracket (not shown in the drawings) as shown in FIG. 3. The mechanical member 35 has a base part 35a lying horizontally and two brackets 35b extending vertically upward from the base part 35a. The brackets 35b are each provided with bearings 36 supporting a supporting body 32 so that the supporting body 32 can rotate around an axial line AL which corresponds to a center line of the air channel body 2a.

The supporting body 32, which functions as a supporting body, is a hollow cylindrical member having a cavity 32b (see (c) in FIG. 4) open at one side thereof (right-hand side in FIG. 3). A cartridge 33 is joined with an effusing body 34, and is installed inside the supporting body 32. The cartridge 33 is a solution supply container. In the present embodiment, the cartridge 33 supplies the effusing body 34 with a material for nanofibers, that is, the solution 20 stored in a cylindrical container 33a which is part of the cartridge 33. A driven pulley 39 is attached onto an outer circumference surface of the supporting body 32, and a drive pulley 42 is joined with a rotation shaft of a motor 41 horizontally disposed on a lower side of the base part 35a. The driven pulley 39 and the drive pulley 42 are provided with a transmission belt 40. The supporting body 32 is rotated around the axial line AL by driving the motor 41, and thereby the cartridge 33 and the effusing body 34 integrally rotate. In addition, the supporting body 32 supports the effusing body 34 and the cartridge 33, maintaining the coupling therebetween.

The supporting body 32 has a closed end at which an air intake hole 32a is provided. The air intake hole 32a communicates with the air tube 15 through a rotary joint 43. The air tube 15 is connected to an air tube 44 through which air is supplied from the air supply source 13 via the air supply joint 14 which is detachable. With this, air for pressurization can be supplied from the air tube 15, which is static, into the cavity 32b of the supporting body 32 which is rotating. When the solution effusing unit 10 is replaced with another as described below, the air tube 44 is attached to and detached from the air supply joint 14.

The rotary joint 43 is configured so as to allow rotation of the supporting body 32 and keep the pressure of air passing through the rotary joint 43. In the case where air is used as a fluid to pressurize the inside of the cartridge 33, the rotary joint 43 having a small air leakage is still preferable as long as the pressure of air is maintained within a predetermined range because such an air leakage does not affect an ambient environment.

Another possible pressurizing unit for pressurization of the inside of the solution supply container, which is exemplified by the cartridge 33, is a device which pushes a solution into the solution supply container to supply a pressurized solution into the solution supply container so as to maintain the pressure of the solution previously supplied into the solution supply container and thereby supply the solution to the effusing body 34. In this case, unlike in the present embodiment, a pressurizing member 38, which is a movable partition to isolate the solution and air from each other, is not necessary. Optionally, the solution supply container and the supporting body may be integrated.

The air blower device 3 adjacent to the effusing device 2 includes a blowing mechanism 30 such as an axial-flow fan and a heating unit 31 provided on a downstream side of the blowing mechanism 30. Air heated by the heating unit 31 is blown by the blowing mechanism 30 into the air channel body 2a of the effusing device 2, and flows in the air channel body 2a in the downstream direction.

As shown in (a) in FIG. 4, the cylindrical container 33a, which is part of the solution supply container, has a protrusion 33b on an outer surface at a distal end part thereof, and the protrusion 33b has a discharging hole 33c for discharging a solution. The protrusion 33b is provided with an external thread part 33d around an outer circumference surface thereof so that the cartridge 33 and the effusing body 34 are joined. The pressurizing member 38 is slidably fit in the cylindrical container 33a so as to isolate the accumulated solution 20 therein from the atmosphere (such as air). Pressure is applied from the outside to the pressurizing member 38 so that the solution 20 is discharged from the discharging hole 33c.

Although pressure is applied to the pressurizing member 38 using air in the present embodiment, pressure may be applied using a fluid other than air or a mechanism such as a spring mechanism.

The effusing body 34 is a member having an outer shape of a cylinder partly cut off in its circumference, and is conductive so that the effusing body 34 can apply an electric charge to the solution 20 while effusing the solution 20. The effusing body 34 has an effusing disc 34b on one end thereof. The effusing disc 34b is approximately discoid in shape and has a plurality of effusing holes 34c in an outer circumference surface thereof. The solution 20 is radially effused through the effusing holes 34c. The effusing holes 34c communicate with an interior space 34a through a leading part 34d, and an intake hole 34f which is open to the interior space 34a is further open to a depression 34e for the coupling of the effusing body 34 and the cartridge 33.

The depression 34e is provided with an internal thread part 34g around an inner circumference surface thereof. The external thread part 33d of the cartridge 33 is screwed with the internal thread part 34g. The effusing body 34 has an extension part 34h extending from the outer circumference surface at the other end thereof. The extension part 34h is used for fastening the effusing body 34 with the supporting body 32 and has an inner circumference surface 34i which is a fastening surface to engage with an outer circumference surface 32d of an open end part 32c of the supporting body 32.

The cartridge 33 is installed in the support 32 in the following manner. First, the cartridge 33 and the effusing body 34 shown in (a) in FIG. 4 are joined to form a first joined body 50 as shown in (b) in FIG. 4. Specifically, the external thread part 33d is screwed with the internal thread part 34g to fit the external thread part 33d in the depression 34e. The inside of the cylindrical container 33a thus communicates with the interior space 34a of the effusing body 34 through the discharging hole 33c and the intake hole 34f. Then, the first joined body 50 of the cartridge 33 and the effusing body 34 is installed to the cavity 32b as shown in (c) in FIG. 4. At this time, the inner circumference surface 34i inside the extension part 34h is engaged with the outer circumference surface 32d, which is the outer surface at the open end part 32c.

Although the solution supply container exemplified by the cartridge 33 and the effusing body 34 are threadedly joined in a detachable manner in the present embodiment, the present invention is not limited to this.

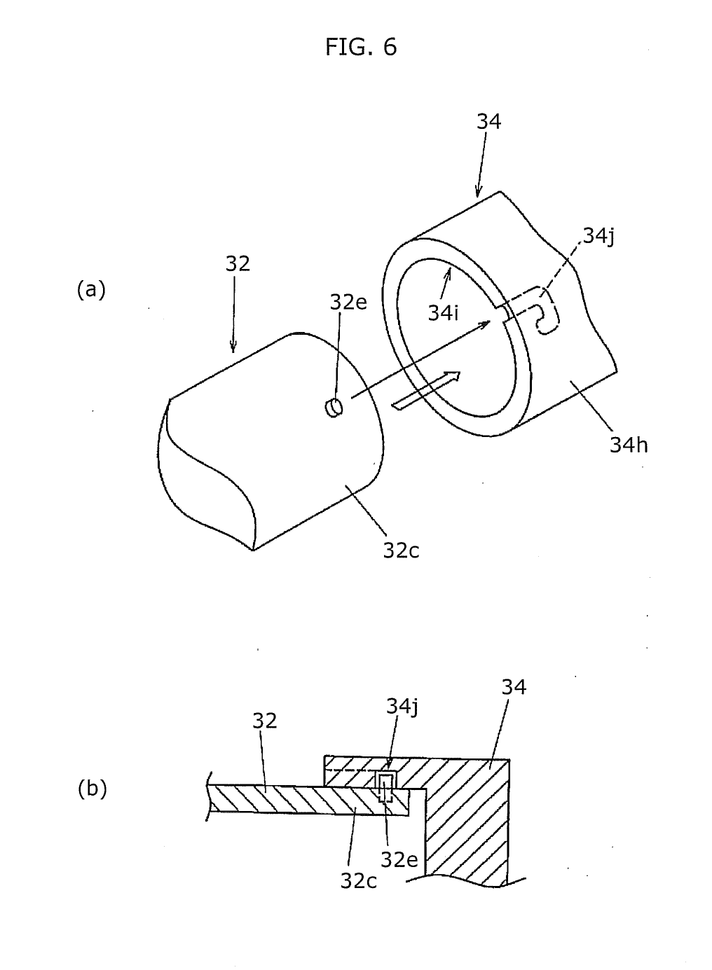

FIG. 6 shows a configuration of an engaging part for engaging the open end part 32c to the inner circumference surface 34i. As shown in (a) in FIG. 6, a locking protrusion part 32e is provided on the outer circumference surface of the open end part 32c, and a locking slot 34j for locking the locking protrusion part 32e is formed in the position on the inner circumference surface 34i so as to correspond to the locking protrusion part 32e. The locking slot 34j has elbow shaped bends. In order to couple the supporting body 32 and the effusing body 34, the locking protrusion part 32e is inserted into the locking slot 34j, and the supporting body 32 is rotated in its circumferential direction along the elbow shaped bends of the locking slot 34j. By doing this, the locking protrusion part 32e is locked with the locking slot 34j as shown in (b) in FIG. 6, and thus the supporting body 32 and the effusing body 34 are joined.

Since the solution supply container and the effusing body 34 are detachably joined as described above, the inside of the effusing body 34 can be easily cleaned, and easy maintenance prevents the effusing hole of the effusing body 34 from clogging. In addition, when two or more of effusing bodies 34 are prepared, an unexpected incident can be quickly dealt with by replacing the effusing bodies.

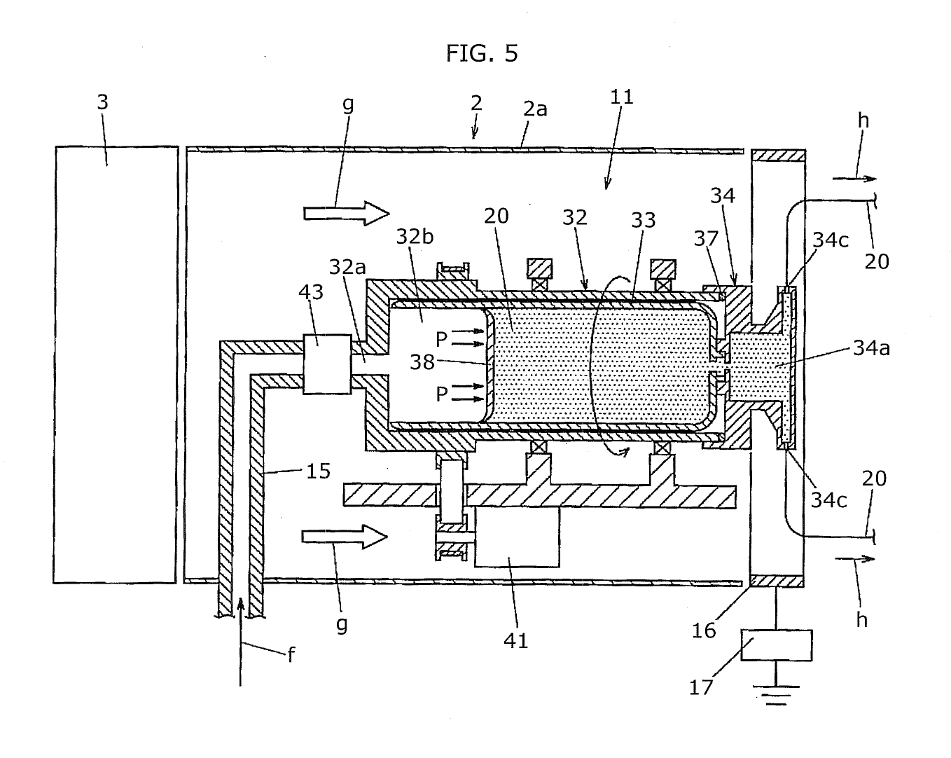

FIG. 5 shows an operation in which the first joined body 50 is installed to the supporting body 32 of the solution effusion mechanism 11. In this configuration, the supporting body 32, the effusing body 34, and the cartridge 33 are integrally rotated around the axial line AL shown in FIG. 3 by driving the motor 41. Then, air for pressurization is sent through the air tube 15 (an arrow f) and delivered to the rotating supporting body 32 through the rotary joint 43, so that an air pressure P works on the pressurizing member 38 in the cavity 32b. The solution 20 in the cartridge 33 is thereby pressurized to flow into the interior space 34a of the effusing body 34, and then effused through the effusing holes 34c in the form of threads.

In this configuration, the supporting body 32 is configured so as to support the cartridge 33 and the effusing body 34 which are joined (that is, the first joined body 50) so that the first joined body 50 is detachable by moving in a direction of the axial line AL of the cylindrical container 33a, and to be rotatable around the axial line AL. The driven pulley 39, transmission belt 40, motor 41, and drive pulley 42 serve as a rotating unit which rotates the effusing body 43 together with the cylindrical container 33a around the axial line through the supporting body 32. The air supply joint 14, air tube 15, and rotary joint 43 form a pressurizing unit which pushes the solution 20 from the cartridge 33 into the interior space 34a by pressurizing the inside of the cylindrical container 33a to cause the solution 20 to be effused through the effusing holes 34c when the first joined body 50 is supported by the supporting body 32 so that the cartridge 33 communicates with the effusing body 34.

The nanofiber manufacturing apparatus 1 further includes a charging unit which charges the solution 20 by applying an electric charge to the solution 20 via the effusing body 34. The charging unit includes the annular electrode 16 and the charging power supply 17. The annular electrode 16 circumferentially encircles and covers the effusing body 34. The charging power supply 17 is a voltage generation unit for applying a predetermined electric field between the annular electrode 16 and the effusing body 34. The annular electrode 16 is a member which induces charges in the effusing disc 34b of the effusing body 34 and is formed into an annular provided so as to surround the effusing body 34. When a positive voltage is applied to the annular electrode 16, negative charges are induced in the effusing body 34. When a negative voltage is applied to the annular electrode 16, positive charges are induced in the effusing body 34.

A grounding device 18 is electrically connected to the effusing body 34 in order to maintain the effusing body 34 at a ground potential. One end of the grounding device 18 functions as a brush to maintain conduction of the supporting body 32, which conducts electricity while connected to the effusing body 24, even while the supporting body 32 is rotating. The other end is grounded. The grounding device 18 needs to be electrically connected to the effusing body 34 but may have a small clearance from the supporting body 32. In particular, in the case where at least one of the supporting body 32 and the grounding device 18 has a plurality of apical end portions which causes ionic wind, the supporting body 32 and the grounding device 18 are thereby electrically connected even with a small clearance therebetween.

Generally, the charging power supply 17 which applies a high voltage to the annular electrode 16 is preferably a direct-current power supply. In particular, use of a direct current is preferable when the charging power supply 17 is not influenced by the charge polarity of the generated nanofibers 20a or when the generated nanofibers 20a that are charged are conveniently attracted by an electrode to which a potential of a reverse polarity is applied. In addition, when the charging power supply 17 is a direct-current power supply, the voltage applied to the annular electrode 16 by the charging power supply 17 is preferably within a range of 10 kV to 200 kV. When a negative voltage is applied to the charging power supply 17, the polarity of the voltage to be applied to is negative. Of particular importance is electric field intensity between the effusing body 34 and the annular electrode 16. The field strength is preferably adjusted to 10 kV/cm or higher in a gap where the annular electrode 16 and the effusing body 34 are closest to each other.

In the induction system in which one of the electrodes of the charging unit is at a ground potential as in the present embodiment, it is possible to apply an electric charge to the solution 20 with the effusing body 34 kept at the ground potential. When the effusing body 34 is at the potential ground, it is unnecessary to electrically insulate the members connected to the effusing body 34 from the effusing body 34. It is convenient that the effusing device 2 can have such a simple structure. An electric charge may be applied to the solution 20 by a charging unit in which the effusing body 34 is connected to a power supply so that the effusing body 34 is kept at a high voltage and grounding the annular electrode 16.

When the charging power supply 17 is in operation, a predetermined voltage is applied to between the annular electrode 16, which is circumferentially provided to the effusing body 34, and the effusing body 34, which is conductive, so that the solution 20 effused through the effusing holes 34c is charged. The solution 20 effused through the effusing holes 34c is acted by centrifugal force due to the rotation of the effusing body 34 and the potential between the solution 20 and the annular electrode 16, and thereby flows from the effusing body 34 toward the annular electrode 16. At this time, the air blower device 3 operates to generate an airflow flowing downstream from the air blower device 3 in the solution effusing unit 10 (an arrow g), so that the solution 20 effused through the effusing hole 34c is deflected in the downstream direction (an arrow h). In other words, the air blower device 3 functions as a flow deflection unit which deflects the flow of the solution 20 effused from the effusing body 34 in a direction along the axial line AL and pushes the solution 20.

The heating unit 31 is a heat source which heats the air to flow as the gas flow generated by the air blower device 3. In the present embodiment, the heating unit 31 is an annular heater provided at the back of the guide body 4 and heats air passing through the heating unit 31. The heating unit 31 heats the gas flow so that vaporization of the solution 20 effused into space is promoted and productivity of the nanofibers 20a is thereby increased.

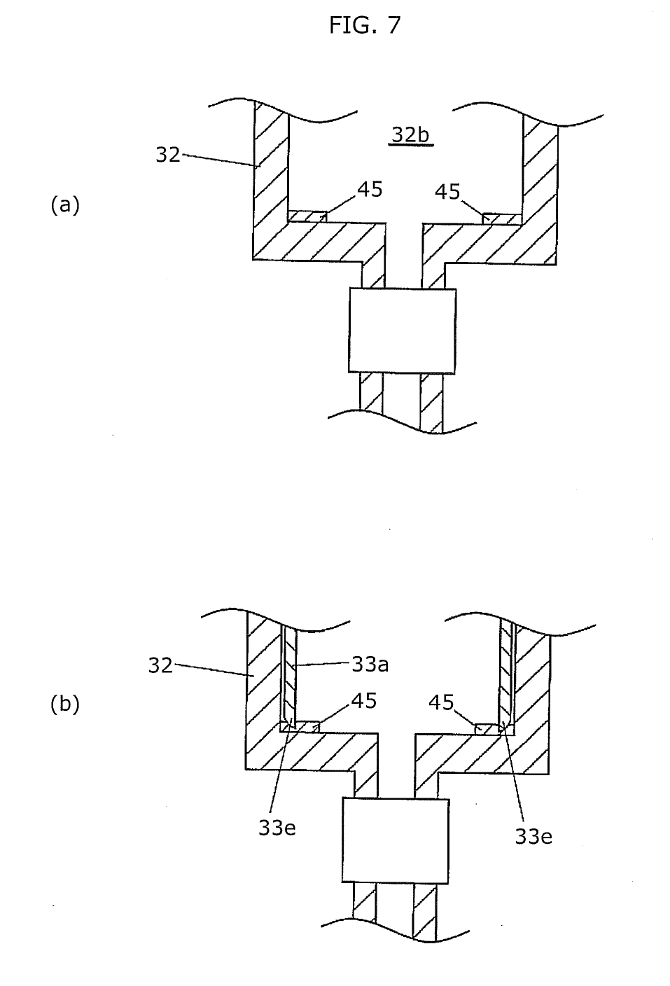

Note that the inside of the effusing disc 34b needs to be sealed against external atmosphere when the supporting body 32 and the effusing body 34 are joined. The inside of the effusing disc 34b illustrated above is sealed using an O-ring 37 intervening between the open end part 32c and the effusing body 34, but the method of sealing the inside of the effusing disc 34b is not limited to this. For example, the inside of the cavity 32b can be sealed using a sealing member 45 attached to a position in the supporting body 32 where the open end part 33e of the cylindrical container 33a is to be in contact with the inside of the cavity 32b as shown in (a) in FIG. 7, in a manner such that the open end part 33e is pressed against the sealing member 45 when the cartridge 33 is inserted into the supporting body 32 as shown in (b) in FIG. 7. The sealing member 45 is made of elastomer, for example.

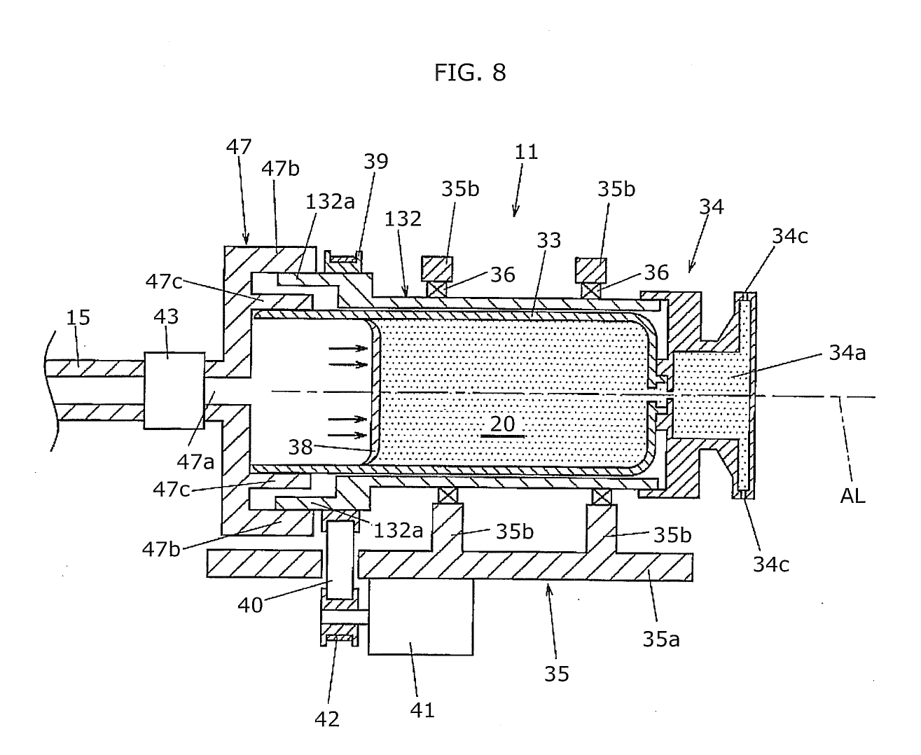

In addition, although the distal end part of the cartridge 33 is connected with the effusing body 34 before being installed in the solution effusion mechanism 11 in the example illustrated in FIG. 3 to FIG. 5, it is also possible to connect a base portion of the cartridge 33 with a holding part 47 beforehand. In this case, a supporting body 132 provided with an open end part 132a having a larger radius at the base portion is used as shown in FIG. 8 instead of the supporting body 32 having the shape shown in FIG. 3.

In this case, the holding part 47 is integrally provided with an air intake hole 47a, a supporting body fastening end part 47b, and a container fastening end part 47c. The air intake hole 47a is open to the rotary joint 43 to take in air for pressurization. The supporting body fastening end part 47b is joined with the open end part 132a. The container fastening end part 47c detachably holds the cartridge 33. In other words, the holding part 47 detachably holds the cartridge 33 and is connected with a pressurizing unit for pressuring the inside of the cylindrical container 33a. Also in this configuration, the motor 41 rotates the supporting body 132 via the transmission belt 40 so that the effusing body 34 rotates around the axial line AL.

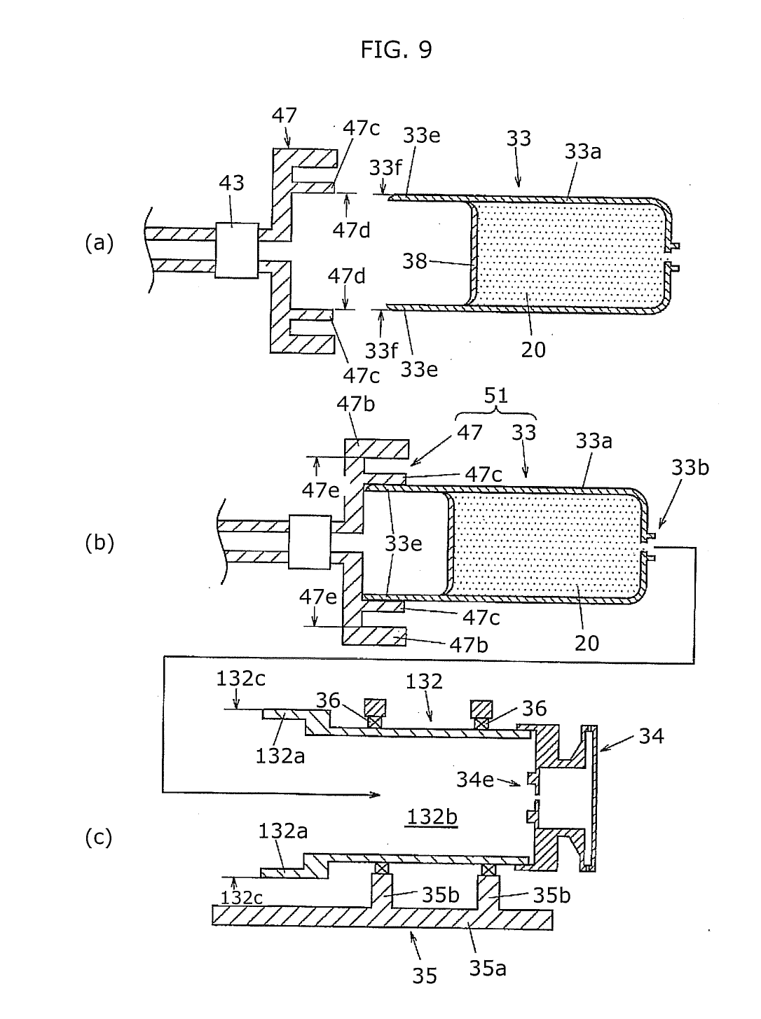

The cartridge 33 containing the solution 20 is installed in the following manner. First, an outer circumference surface 33f at the end part 33e of the cartridge 33 is fit in an inner circumference surface 47d of the container fastening end part 47c as shown in (a) in FIG. 9. By doing this, the cartridge 33 and the holding part 47 are integrally joined to form a second joined body 51 as shown in (b) in FIG. 9. Next, the second joined body 51 is installed in the solution effusion mechanism 11 in which the supporting body 132 and the effusing body 34 have already been joined.

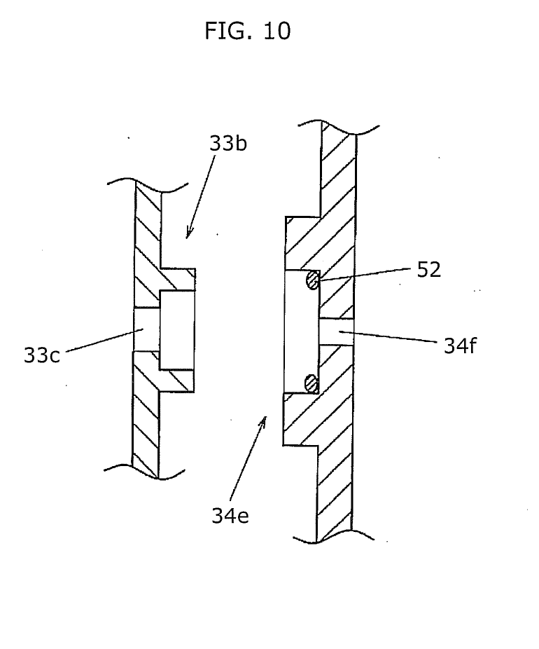

Specifically, the cartridge 33 is inserted into the cavity 132b with the distal end part first. The protrusion 33b is hermetically fit in the depression 34e, and the outer circumference surface 132c of the open end part 132a is fit in the inner circumference surface 47e of the supporting body fastening end part 47b, so that the supporting body 132 and the effusing body 34 are joined. The cartridge 33 and the effusing body 34 thereby communicate with each other. At this time, an O-ring 52 is provided in the depression 34e as shown in FIG. 10 such that the communication between the discharging hole 33c and the intake hole 34f are hermetic when the protrusion 33b fits in the depression 34e.

In the configuration above, the supporting body 132 holds the second joined body 51, which has the effusing body 34 at one end and the cartridge 33 and the holding part 47 on the other end, detachably in an direction along the axial line of the cylindrical container 33a so as to provide communication between the cartridge 33 and the effusing body 34. With the cartridge 33 and the effusing body 34 communicating with each other, the air tube 15 and the rotary joint 43 forming the pressurizing unit is activated to pressurize the inside of the cartridge 33 so that the solution 20 is pushed into the interior space 34a and effused through the effusing holes 34c.

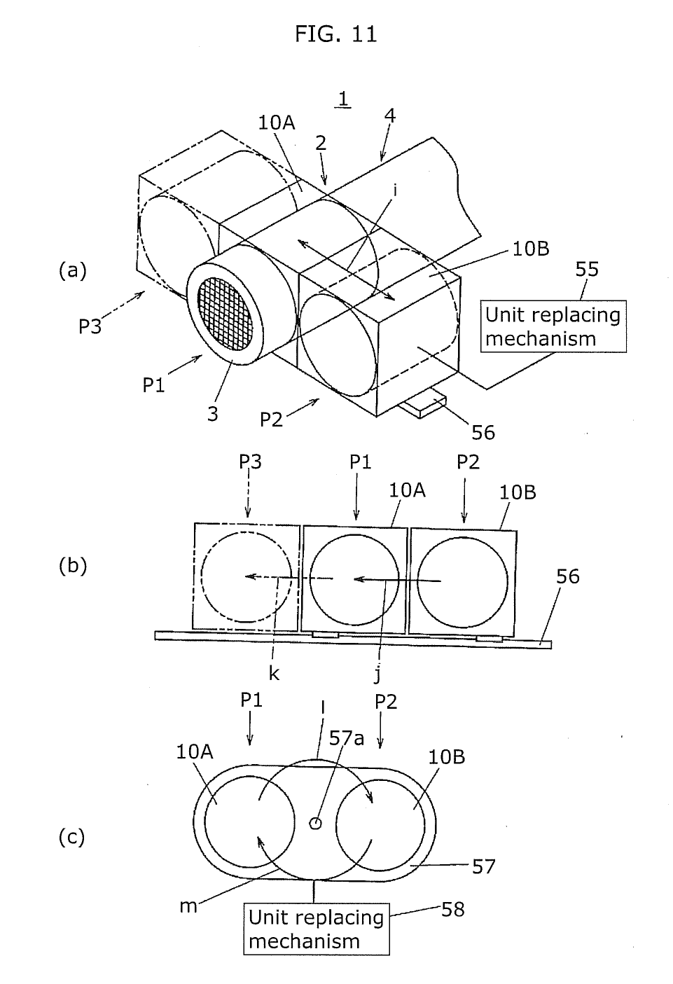

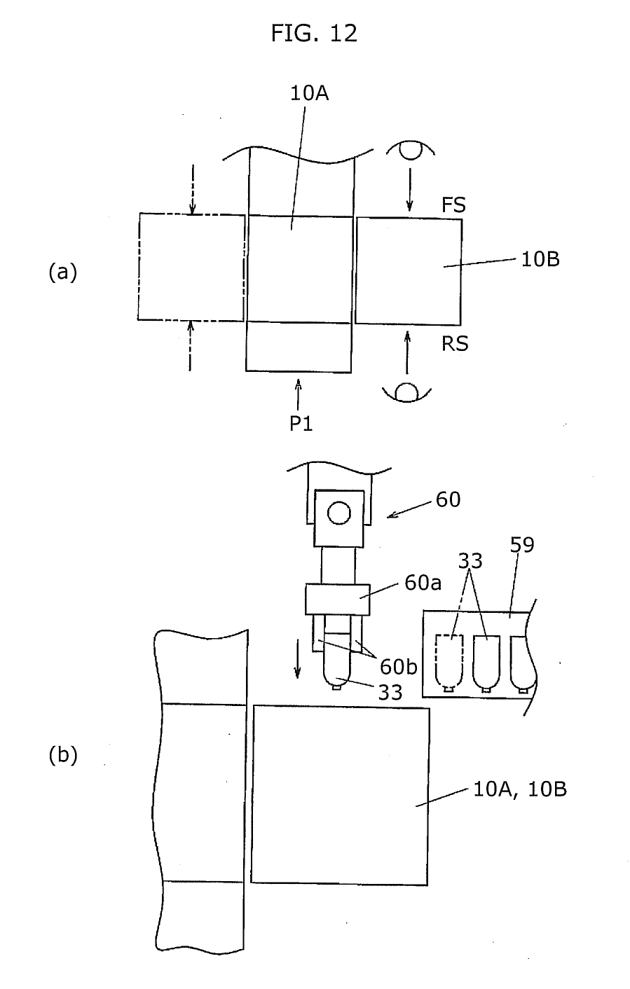

The following describes a process of unit replacement necessary for supply of the solution 20 in the nanofiber manufacturing apparatus 1 with reference to FIG. 11 and FIG. 12. Since the cartridge 33 having the cylindrical container 33a storing a predetermined amount of the solution 20 is used in a method of supply of the solution 20 in the nanofiber manufacturing apparatus 1, the cartridge 33 which has run out of the solution 20 needs to be replaced with a new cartridge 33. At this time, it is not preferable from the viewpoint of availability of the nanofiber manufacturing apparatus 1 to replace the cartridge 33 each time the cartridge 33 runs out of the solution 20 because the operation of the nanofiber manufacturing apparatus 1 needs to be interrupted.

To avoid such interruption, two or more solution effusing units 10 shown in FIG. 2 are prepared for the nanofiber manufacturing apparatus 1 according to the present embodiment in order to replace one solution effusing unit 10 including an empty cartridge 33 with another solution effusing unit 10 in whole so that the cartridges 33 can be switched quickly. In the example illustrated in FIG. 3, each of the solution effusing units 10 is configured as a combination of the cartridge 33, the effusing body 34, the supporting body 32, and the pressurizing unit, rotating unit, and charging unit described above. In the example illustrated in FIG. 8, each of the solution effusing units 10 is configured as a combination of the cartridge 33, the holding part 47, the effusing body 34, the supporting body 132, and the pressurizing unit, rotating unit, and charging unit described above.

As shown in (a) and (b) in FIG. 11, the nanofiber manufacturing apparatus 1 includes a unit replacing mechanism 55 which horizontally (an arrow i) moves solution effusing units 10A and 10B along a guide rail 56 extending horizontally. The effusing units 10A and 10B are configured in the same manner as the solution effusing unit 10 shown in FIG. 2. The unit replacing mechanism 55 is operated so as to position one of the solution effusing units 10A and 10B at a work position P1 so that the effusing device 2 is disposed between the guide body 4 and the air blower device 3, and the other at one of a replacement positions P2 and a replacement position P3 on either side of the work position P1.

For example, when the solution effusing unit 10A is positioned at the work position P1 as shown in (b) in FIG. 11 and in operation there, the solution effusing unit 10B is at the replacement position P2 so that the cartridges 33 can be easily replaced. Subsequently, when the cartridge 33 of the solution effusing unit 10A becomes empty, the unit replacing mechanism 55 is operated to move the solution effusing unit 10B to the work position P1 (an arrow j) and the solution effusing unit 10A to the replacement position P3 (an arrow k), where the cartridge 33 of the solution effusing unit 10A is replaced with another. In other words, the nanofiber manufacturing apparatus 1 in the example includes a unit replacing mechanism which positions one of the solution effusing units 10A and 10B at the work position P1 to produce nanofibers.

In an example shown in (C) in FIG. 11, the two solution effusing units 10A and 10B are held in a unit holder 57, and the unit holder 57 is rotated around a rotation shaft 57a by a unit replacing mechanism 58, instead of being arranged in parallel and moved horizontally. With this, positions of the solution effusing units 10A and 10B are alternately switched between the work position P1 and the replacement position P2. Specifically, when the cartridge 33 of the solution effusing unit 10A at the work position P1 becomes empty, the unit replacing mechanism 58 is operated to move the solution effusing unit 10B to the work position P1 (an arrow m) and the solution effusing unit 10A to the replacement position P2 (an arrow I), where the cartridge 33 of the solution effusing unit 10A is replaced with another.

(a) in FIG. 12 shows an implementation of replacement of cartridges 33 of the solution effusing unit 10A and the solution effusing unit 10B. Specifically, in the configuration illustrated in FIG. 3, the cartridge 33 is taken out from the downstream side (right-hand side of FIG. 3). An operator performs a necessary operation from an front surface side FS shown in FIG. 3. On the other hand, in the configuration illustrated in FIG. 8, the cartridge 33 is taken out from the upstream side (left-hand side of FIG. 8). An operator performs a necessary operation from a rear surface side RS shown in FIG. 8.

Furthermore, (b) in FIG. 12 illustrates a method of automatic replacement of the cartridges 33. Here, the cartridges 33 are stored in a cartridge storage unit 59, and a robotic mechanism 60 performs cartridge replacement. Specifically, a robotic hand 60a is moved and a used one of the cartridges 33 is gripped and held by a chuck mechanism 60b so that the robotic mechanism 60 can automatically remove the used cartridge 33 from the solution effusion mechanism 11 and install a new one of the cartridges 33 in the solution effusion mechanism 11.

The following describes a method of manufacturing the nanofibers 20a by electrically stretching the solution 20 in space using the nanofiber manufacturing apparatus 1 in the configuration described above. Before producing the nanofiber, the cartridge 33 containing the solution 20 is set in the effusing device 2.

Specifically, in the configuration illustrated in FIG. 3, a step of forming a joined body is performed in which the cartridge 33, which is a solution supply container, and the effusing body 34 are joined to form the first joined body 50 (see (b) in FIG. 4). Next, a step of holding a supporting body is performed in which the first joined body 50 is held by the supporting body 32 (see (c) in FIG. 4). In the configuration illustrated in FIG. 8, a step of forming a joined body is performed in which the cartridge 33, which is a solution supply container, and the holding body 47, which detachably holds the cartridge 33 and to which the pressurizing unit for pressurizing the inside of the cylindrical container 33a is connected, are joined to form the second joined body 51 (see (b) in FIG. 9). Next, a step of holding a supporting body is performed in which the second joined body 51 is held on one end of the supporting body 32 having the effusing body 34 installed on the other end (see (c) in FIG. 9).

Next, a step of pushing a solution is performed in which the solution 20 is pushed from the cartridge 33 into the interior space 34a of the effusing body 34 by pressurizing the inside of the cylindrical container 33a. Next, a step of solution effusion is performed in which the pushed solution 20 is effused through the effusing holes 34c while being charged by the charging unit, and the effusion of the solution 20 is promoted by centrifugal force generated by rotating the effusing body 34 and the cylindrical container 33a together around an axial line via the supporting body 32 using the rotating unit. The solution 20 is thereby turned into the nanofibers 20a by electrospinning, which is an application of electrostatic stretching, and the resulting nanofibers 20a are caught and collected by the collection device 5.

Then, when the solution 20 in the cartridge 33 of one of the solution effusing units 10 positioned at the work position P1 for producing the nanofibers 20a is consumed, the solution effusing units 10 is replaced with another one of the solution effusing units 10 by placing the other solution effusing unit 10 at the work position P1 to continue production of the nanofibers 20a. This method minimizes interruption of production due to exhaustion of the solution 20, and thus increases the operating rate of the nanofiber manufacturing apparatus.

The following describes an exemplary process of manufacturing nanofibers 20a according to the present embodiment. First, the air blower device 3 and the suction device 26 are activated to generate a gas flow from the effusing device 2 toward the collecting device 8 in the effusing device 2, the guide body 4, and the concentration part 24 (gas flow generation step). Here, the air flow is controlled so that an airflow rate in the guide body 4 is 30 cubic meters per minute. A resin to be used as a solute in the present embodiment is polyvinyl alcohol (PVA). A solvent of the solution 20 is water. The percentages of the solute and the solvent to the solution 20 are 90% of water and 10% of polyvinyl alcohol. Environmental temperature is set to 20° C. and humidity is set to 35%.

Next, the annular electrode 16 is set at a positive high voltage or a negative high voltage using the charging power supply 17. Charges concentrate at the effusing holes 34c of the effusing body 34 disposed near the annular electrode 16, and the charges transit to the solution 20 to be effused into space through the effusing holes 34c of the effusing body 34, so that the solution 20 is charged (charging step). Concurrently with the step of charging, the effusing body 34 is rotated at a rotation rate of 1500 rpm by driving the motor 41 such that the solution 20 is effused through the effusing holes 34c in a circumferential wall of the effusing body 34 by a predetermined pressure and a predetermined centrifugal force (rotation and effusion step).

Specifically, the effusing body 34 used in the present embodiment has an outside diameter of Φ60 mm. The effusing body 34 has 18 of the effusing holes 34c circumferentially arranged with regular intervals. The effusing holes 34c are circular in shape and have a diameter of 0.3 mm. On the other hand, the annular electrode 16 has an internal diameter of Φ600 mm, and is set at negative 60 kV relative to the ground potential using the charging power supply 17. With this, positive charges are induced to the effusing body 34, and the solution 20 to be effused is positively charged.

The solution 20 effused through the effusing holes 34c first comes in contact with the gas flow (air), and is transferred by the gas flow (transfer step) to reach the guide body 4. Here, since the charged solution 20 and the annular electrode 16 have opposite polarities, the solution 20 is attracted by a Coulomb force so as to fly toward the annular electrode 16 at the beginning. However, the flight direction of most of the solution 20 toward the annular electrode 16 is shifted toward the guide body 4 by the gas flow.

The solution 20 is effused from the effusing device 2 and turned into the nanofibers 20a by electrostatic stretching (nanofiber production step). Here, the effused solution 20 is charged so strongly that the electrostatic stretching easily occurs and most of the effused solution 20 is turned into the nanofibers 20a. In addition, the effused solution 20 is charged so strongly that the electrostatic stretching multiplicatively occurs to the effused solution 20 such that a mass of the nanofibers 20a having small diameters are produced. In addition, the gas flow, which is heated by the heating unit 31, provides heat to the solution 20 in flight while guiding the solution 20. As a result, vaporization of the solvent is increased, so that the electrostatic stretching is promoted.

The nanofibers 20a thus effused from the effusing device 2 are guided to the guide body 4. The nanofibers 20a are then transferred in the guide body 4 toward the collection device 5 by the gas flow (guiding step). The nanofibers 20a transferred to the flare part 4b rapidly slows down and diffuses evenly (diffusion step). Here, the suction device 26 disposed behind the deposition member 6 suctions the vaporized solvent and the gas flow together to draw the nanofibers 20a onto the deposition member 6 (drawing step). In addition, the drawing electrode 22 to which a voltage is applied generates an electric field, and the electric field also draws the nanofibers 20a (drawing step).

The nanofibers 20a are thus separated from the gas flow by the deposition member 6 and accumulated (accumulation step). The deposition member 6 is slowly transferred by the member retrieving unit 5b, so that the collected nanofibers 20a have a band-like shape extending in the direction of the transfer. The gas flow after passing through the deposition member 6 is accelerated by the suction device 26 and reaches the collecting device 8. In the collecting device 8, the solvent is separated and collected from the gas flow (collection step).

In the method of manufacturing nanofibers using the nanofiber manufacturing apparatus 1 in the configuration described above, the solution 20 in the cartridge 33 is pressurized by a fluid pressure so that the solution 20 is effused through the effusing holes 34c. As a result, the solution 20 is pushed out through the effusing holes 34c at a stable rate, regardless of the amount of the solution 20 remaining in the cartridge 33. In addition, this and centrifugal force due to rotation of the effusing body 34 together allow constant and even radial effusion of the solution 20.

Consequently, the problem that the effused solution 20 fails to form a thread but forms droplets to scatter without causing electrostatic stretching and the problem that generated nanofibers are poor in quality with uneven fiber diameters are avoided, so that productivity can be increased. In the example under the conditions above, the fiber diameters of the generated nanofibers 20a vary within a range of 500 to 700 nm, which shows the advantageous effect of the present invention.

Furthermore, since the solution 20 is always in the cartridge 33 and only the air for pressurization is supplied through the rotary joint, quality deterioration caused by heat denaturation of the solution 20 due to heat generation of the rotary joint, which is the problem with the configuration in which the pressurized solution 20 is supplied to the effusing body 34 in rotation through the rotary joint, is avoided.

Furthermore, since the solution 20 in the present embodiment is supplied sealingly in the cartridge 33 and not exposed to air until being effused out of the effusing hole 34c, the solution 20 of stable quality can be continuously effused into space, enabling stable production of the nanofibers 20a of high quality for a long time. This also prevents solidification of resin in the solution 20 in the effusing holes 34c, so that the number of maintenance operations for eliminating clogging in the effusing holes 34c can be reduced.

It is to be noted that present invention is not limited to the present embodiment. For example, in another embodiment of the present invention, the constituent elements described in the present description may be optionally combined. Any variations of the present embodiment to be conceived by those skilled in the art without departing from the spirit of the present invention, that is, the meaning of the wording in the claims, are also within the scope of the present invention.

For example, although the effusion of the solution is promoted by centrifugal force generated by rotating the effusing body using the rotating unit in the present embodiment, the solution can be effused only by pressure applied by the pressurizing unit, without using the rotating unit.

### INDUSTRIAL APPLICABILITY

The nanofiber manufacturing apparatus and the method of manufacturing nanofibers according to an aspect of the present invention is characterized in that nanofibers having a uniform fiber diameter can be stably and efficiently produced using the apparatus or the method, and thus the apparatus and the method are applicable to manufacture of nanofibers having a submicron-scale diameter and yarns or unwoven cloth of nanofibers.

### REFERENCE SIGNS LIST

1 Nanofiber manufacturing apparatus
2 Effusing device
3 Air blower device
4 Guide body
5 Collection device
6 Deposition member
7 Drawing unit
8 Collecting device
10, 10A, 10B Solution effusing unit
11 Solution effusion mechanism
13 Air supply source
14 Air supply joint
15 Air tube
16 Annular electrode
17 Charging power supply
20 Solution
20a Nanofiber
21 Electric-field drawing device
22 Drawing electrode
23 Drawing power supply
24 Concentration part
25 Gas drawing device
30 Blowing mechanism
31 Heating unit
32 Supporting body
33 Cartridge
33a Cylindrical container
34 Effusing body
34a Interior space
34c Effusing hole
37 O-ring
38 Pressurizing member
39 Driven pulley
40 Transmission belt
41 Motor
43 Rotary joint
50 First joined body
51 Second joined body

1. A nanofiber manufacturing apparatus which produces nanofibers by electrically stretching a solution in space, said nanofiber manufacturing apparatus comprising:
an effusing body having an interior space into which the solution is supplied and a plurality of effusing holes through which the solution is radially effused from the interior space;
a solution supply container having a connection to said effusing body in a detachable manner and configured to supply said effusing body with the solution stored in said solution supply container;
a supporting body which supports said solution supply container and said effusing body while maintaining the connection between said solution supply container and said effusing body;
a pressurizing unit configured to pressurize an inside of said solution supply container so that the solution is supplied from said solution supply container to the interior space of said effusing body, when the connection between said solution supply container and said effusing body is maintained; and
a charging unit configured to charge the solution by applying an electric charge to the solution via said effusing body.

2. The nanofiber manufacturing apparatus according to claim 1,
wherein said supporting body maintains the connection between said solution supply container and said effusing body, and rotatably supports said solution supply container and said effusing body, and
said nanofiber manufacturing apparatus further comprises
a rotating unit configured to rotate said effusing body and said solution supply container integrally.

3. The nanofiber manufacturing apparatus according to claim 1,
wherein said pressurizing unit is configured to apply the pressure to the inside of said solution supply container by introducing a fluid into the inside of said solution supply container.

4. The nanofiber manufacturing apparatus according to claim 3,
wherein the fluid is a gas, and
said solution supply container includes a partition which isolates the solution from the introduced gas.

5. The nanofiber manufacturing apparatus according to claim 3,
wherein the fluid is the solution.

6. The nanofiber manufacturing apparatus according to claim 1,
wherein said charging unit includes:
an annular electrode circumferentially covering said effusing body; and
a voltage generation unit configured to apply a predetermined electric field between said annular electrode and said effusing body, and
said nanofiber manufacturing apparatus further comprises
a flow deflection unit configured to deflect a flow of the solution effused from said effusing body and push the solution.

7. The nanofiber manufacturing apparatus according to claim 1, further comprising:
a plurality of solution effusing units each of which integrally includes said solution supply container, said effusing body, and said supporting body; and
a unit replacing unit configured to replace one of said solution effusing units at a work position for producing nanofibers with an other one of said solution effusing units.

8. A nanofiber manufacturing method to be used by a nanofiber manufacturing apparatus which produces nanofibers by electrically stretching a solution in space,
the nanofiber manufacturing apparatus including:
an effusing body having an interior space into which the solution is supplied and a plurality of effusing holes through which the solution is radially effused from the interior space;
a solution supply container having a connection to the effusing body in a detachable manner and configured to supply the effusing body with the solution stored in the solution supply container;
a supporting body which supports the solution supply container and the effusing body while maintaining the connection between the solution supply container and the effusing body;
a pressurizing unit configured to pressurize an inside of the solution supply container so that the solution is supplied from the solution supply container to the interior space of the effusing body, when the connection between the solution supply container and the effusing body is maintained; and
a charging unit configured to charge the solution by applying an electric charge to the solution via the effusing body, and
said nanofiber manufacturing method comprising:
coupling the solution supply container and the effusing body;
supporting the joined solution supply container and the effusing body in a detachable manner;
pressurizing an inside of the solution supply container so that the solution is supplied from the solution supply container to the interior space of the effusing body; and
effusing the solution supplied from the solution supply container through the effusing holes while charging the solution using the charging unit.

9. The method of manufacturing nanofibers according to claim 8,
wherein, in said effusing, the effusing body is rotated integrally with the solution supply container using a rotating unit so that centrifugal force promotes effusion of the solution.

10. The nanofiber manufacturing apparatus according to claim 2,
wherein said pressurizing unit is configured to apply the pressure to the inside of said solution supply container by introducing a fluid into the inside of said solution supply container.

11. The nanofiber manufacturing apparatus according to claim 10,
wherein the fluid is a gas, and
said solution supply container includes a partition which isolates the solution from the introduced gas.

12. The nanofiber manufacturing apparatus according to claim 10,
wherein the fluid is the solution.
